(19) United States
(12) Patent Application Publication
(10) Pub. No.: US 2009/0263232 A1
(43) Pub. Date: Oct. 22, 2009

(54) COMPACT AIR COOLING SYSTEM

(75) Inventor: YOUSEF JARRAH, Tuscon, AZ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Minebea Co., Ltd., Tokyo (JP)

(21) Appl. No.: 12/105,132

(22) Filed: Apr. 17, 2008

(51) Int. Cl. F03D 7/06

(52) U.S. Cl. 415/4.4

(57) ABSTRACT

An apparatus for air cooling an object. The apparatus includes a plate including a first surface and a second surface and a plurality of aerodynamic fins being fixedly disposed on the first surface in an arrangement along periphery of the plate. The arrangement of the plurality of aerodynamic fins defining a central volume of space. Additionally, the apparatus includes a blower including a plurality of impeller blades rotatably disposed within the central volume of space for rotary motion about an axis of rotation. In particular, the second surface is for thermally contacting with the object and the axis of rotation is substantially perpendicular to the first surface. Furthermore, the rotary motion of the blower creates an air inflow along the axis of rotation into the central volume of space and an air outflow through the plurality of aerodynamic fins in radial directions.

### BACKGROUND OF THE INVENTION

The present invention relates generally to fluid flow processing techniques, and in particular to a method and an apparatus for effectively air cooling of an object via both conduction and convention.

In conventional techniques diffusing heat sink is usually not an integral part of a blower. In certain conventional applications, for example, for cooling an assembly of electronics products, an axial fan is usually deployed for creating an one directional flow of air above a heated area to take the heat away. But no conducting plate is used. In certain improved applications, heat sink fins may be applied on top of the heated area so that heat firstly is conducted from the operating hot devices through a conductive plate to the heat sink fins and the air within the assembly is heated. Then the axial fan creates an air flow to remove the hot air out in substantially one direction. But, the axial fan usually is deployed separately which takes more space; the one-dimensional inflow of cold air and outflow of hot air are sometime not efficient enough to remove heat out of the assembly. In many new electronics applications, reduced product dimension has limited the space allowed for the cooling apparatus. Correspondingly it is desirable to have an improved method and apparatus of air cooling an object by effectively utilizing both conduction and convection within a single compact unit.

However, the prior arts are lacking to meet the specific requirements mentioned above and beyond in terms of the particular constructional improvements of the invention described in detail hereinafter. For example, blower bladed diffuser is made into an integral part of the heat sink and the back plate is used as a heat spreader by itself. The nature of the improvements is brought out more clearly in the detailed description hereinafter of the preferred embodiment.

### BRIEF SUMMARY OF THE INVENTION

The present invention relates generally to fluid flow processing techniques, and in particular to an apparatus that integrally combines a motorized blower with radial impeller blades in association with diffuser fins over a conductive plate into a single compact unit and a method of generating radial air flow to effectively cool an object by both conduction and convention. But it should be applicable to much broader areas of fluid flow processing.

In a specific embodiment, the invention provides an apparatus for air cooling an object. The apparatus includes a plate including a first surface and a second surface. Additionally, the apparatus includes a plurality of aerodynamic fins being fixedly disposed on the first surface in an arrangement along periphery of the plate. The arrangement of the plurality of aerodynamic fins defines a central volume of space. Moreover, the apparatus includes a blower impeller rotatably disposed within the central volume of space for rotary motion about an axis of rotation. Associated with the apparatus, the second surface is for thermally contacting with the object and the axis of rotation is substantially perpendicular to the first surface. Furthermore, the rotary motion of the blower impeller creates an air inflow into the central volume of space along the axis of rotation and an air outflow in radial directions through the plurality of aerodynamic fins.

In another specific embodiment, the present invention provides apparatus for processing fluid flow. The apparatus includes a circular plate and a plurality of curved fins being disposed in an arrangement radially about periphery of the circular plate. The arrangement of the plurality of curved fins defines a central volume of space. Moreover, the apparatus includes a blower impeller including a rotor enclosed within a housing and a plurality of impeller blades coupled to the rotor for rotary motion about an axis of rotation. The housing is fixedly attached with the circular plate and occupied an inner circumferential portion of the central volume of space. The plurality of impeller blades are radially arranged to occupy an outer circumferential portion of the central volume of space such that the outer circumferential portion is spaced apart a first gap from the inner circumferential portion and a second gap from the plurality of curved fins. Furthermore, the rotary motion of the plurality of impeller blades creates a fluid inflow into the first gap within the central volume of space along the axis of rotation and drives a fluid outflow crossing the second gap and passing through the plurality of curved fins in radial directions.

In an alternative embodiment, the present invention provides a method of cooling an object. The method includes providing an air cooling apparatus which includes a plate having a first surface and a second surface and a plurality of airfoil-shaped fins being integrally coupled with the first surface in a radial arrangement along periphery of the plate. The radial arrangement of the plurality of airfoil-shaped fins defines a central volume of space. The air cooling apparatus further includes a blower impeller including a plurality of impeller blades radially coupled to a rotor, the blower impeller being rotatably disposed within the central volume of space for rotary motion about an axis of rotation. The axis of rotation is perpendicular to the first surface. Additionally, the method includes making a thermal contact between the second surface and the object, thereby conducting heat from the object through the plate to the plurality of airfoil-shaped fins. The method further includes driving the rotary motion of the plurality of impeller blades by powering the rotor. Furthermore, the method includes creating an inflow of air along the axis of rotation into the central volume of space. Moreover, the method includes driving the air through the plurality of airfoil-shaped fins to diffuse the heat out in radial directions.

Many benefits are achieved by applying embodiments of the present invention. An embodiment enhances the heat removal process by utilizing the blower bladed-diffuser. Each of the diffuser blades or fins is a heat sink and surfaces of diffuser plate act as a heat spreader. Another embodiment with the blower impeller being embedded in the central portion of the diffuser fins makes the overall unit very compact and reduces cost of manufacture compared to making a separate fan unit in addition to the heat spreader. This is very useful for many new generation electronics products requiring much tighter assembly spacing and more stringent demand on cooling efficiency. Certain embodiments of the present invention make the air cooling more efficient by removing the heat through effectively combined conduction and convection.

### BRIEF DESCRIPTION OF THE DRAWINGS

FIG. 1 is a schematic diagram of an assembled apparatus according to an embodiment of the present invention;

FIG. 2 is a schematic diagram of the apparatus of FIG. 1 partially disassembled according to an embodiment of the invention;

FIG. 3 is a schematic top view of a plurality of fins radially disposed on a circular plate of the apparatus according to an embodiment of the invention;

FIG. 4 is a schematic top view of a blower impeller with a plurality of impeller blades coupled to a rotor being associated with the plurality of fins of FIG. 3 according to an embodiment of the invention;

FIG. 5 is a cross sectional view illustrating an exemplary arrangement of both the plurality of fins and plurality of impeller blades according to an embodiment of the present invention; and

FIG. 6 is a schematic diagram illustrating a method of using the apparatus according to an embodiment of the present invention.

### DETAILED DESCRIPTION OF THE INVENTION

The present invention relates generally to fluid flow processing techniques, and in particular to an apparatus that integrally combines a motorized blower with radial impeller blades in association with diffuser fins over a conductive plate into a single compact unit and a method of generating radial air flow to effectively cool an object by both conduction and convention. But it should be applicable to much broader areas of fluid flow processing.

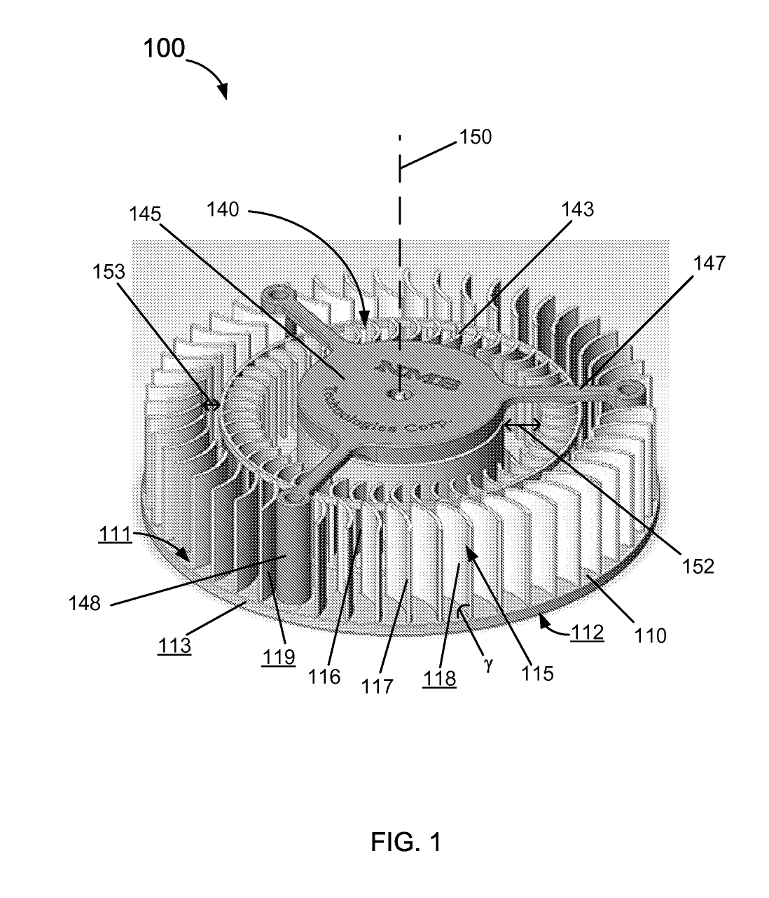

FIG. 1 is a schematic diagram of an assembled apparatus according to an embodiment of the present invention. This diagram is merely an example, which should not unduly limit the scope of the claims herein. One of ordinary skill in the art would recognize many variations, alternatives, and modifications. As shown, the apparatus 100 includes a base plate 110 which is made from heat-conducting materials and can have a variety of shapes. For example, the shape can be a polygon, a circle, an oval, or others. Preferably the base plate 110 is a circular plate. The base plate 110 includes a top surface 111, a bottom surface 112, and a periphery 113. In one example, the apparatus is used as an air cooling apparatus wherein the bottom surface 112 can be applied to make a thermal contact with an object, such as an electronics device, that needs cooling. The base plate 110 itself is made of thermally conductive material including alloys of aluminum, or alloys of copper, or conductive polymer or plastics for maximize heat conduction. In certain embodiments, the bottom surface 112 may not be limited to flat surface, instead can be in arbitrary shape conforming with specific shape of the object. The top surface 111 is usually a flat surface for incorporation of other elements of the apparatus. Of course, there can be many alternatives, variations, and modifications.

Referring to FIG. 1 again, on the top surface 111 a plurality of fins 115 are integrally fixed in an arrangement about the periphery 113. In one embodiment, plurality of fins 115 are made of thermally conductive materials to serve as heat sinks to the plate. For example, the fins can be made of alloys of aluminum, or alloys of copper, or conductive polymer or plastics. When applying the apparatus for cooling the object, heat is conducted from the bottom surface 112 through the plate 110 to the top surface 111 and passed to the plurality of fins 115 which provide large extra surface area for diffusing the heat to surrounding environment. In certain embodiment, these heat sink fins are substantially identical in physical size and shape. Though in other embodiments, different sized or shaped fins can be used for specific cooling application on certain objects with special shapes and/or specific assembly requirements.

As an example, FIG. 1 shows that the plate is a circular shape and each of the plurality of fins 115 is substantially identical in size and shape and fixedly disposed with substantially equal spacing along a peripheral region of the plate 110. In one embodiment, each of the plurality of fins 115 is curved to an airfoil shape in radial direction to facilitating air flow and maximize heat transfer to the air. In a specific embodiment, each of the plurality of fins 115 includes a concave side surface 118 from a leading edge 116 to a trailing edge 117 and a convex side surface 119 opposing to the concave side surface 118. In one example, the concave side surface 118 and the convex side surface 119 are in parallel to each other and may forms a side angle γ relative to the top surface 111 of the plate 110. In a preferred embodiment, the side angle γ is about 90 degrees (in other words, each fin 115 is substantially perpendicular to the top surface 111). In another specific embodiment, the trailing edge 117 is located near the periphery 113 and the leading edge 116 is located near the central part of the plate to face radially incoming air flow from the central area of the plate 110. In one example, as shown in FIG. 1, the trailing edge 117 is substantially aligned with the periphery edge of the plate. The leading edges 116 of all set of fins fall into a circle on the central portion of the top surface 111, defining a central volume of space above an area within the circle. Of course, there can be many variations, alternatives, and modifications. For example, the plurality of fins 115 may not be limited to one size and may vary in spatial arrangements associated with the specific shape of the plate 110. More detailed descriptions of an arrangement of the set of fins on the top surface of the plate can be found in following paragraphs.

Additionally the apparatus includes a blower impeller for radial flow processing. As shown in FIG. 1, the blower impeller 140 is rotatably disposed within the central volume of space for rotary motion about an axis of rotation. In one embodiment, the blower impeller 140 includes a rotor (not visible) enclosed within a housing 145 around the axis of rotation 150. For example, the rotor can be made from a variety of micro motor products provided by NMB (USA) Inc., a division of Minebea Co. LTD. Japan, or from any other motor suppliers. Specifically, the axis of rotation 150 is perpendicular to the top surface 111. In one example, the plate 110 is in a circular shape that is co-axial with the axis of rotation 150 at the center of the plate 110. In another example, the central volume of space also is co-centered with the circular plate 110. The housing 145 occupies a central circumferential portion around the axis of rotation 150. The blower impeller 140 also includes a plurality of impeller blades 143 radially coupled to the rotor and arranged with an equal radius around an outer circumferential portion within the central volume of space. In one example, each impeller blade 143 is in parallel relation to the axis of rotation 150. Therefore, the rotary motion of the blower impeller 140 driven by the rotor effectively drive the air to flow in radial directions by the plurality of impeller blades 143.

In a specific embodiment, the outer circumferential portion occupied by the plurality impeller blades 143 is spaced apart by a gap 152 from the housing 145 at the inner portion of the central volume of space to bring in the air along the axis of rotation 150 into the plurality of impeller blades 143. At the same time, the outer circumferential portion also is spaced apart by another gap 153 from the plurality of fins 115 to allow free rotary motion of the plurality of impeller blades 143 within the central volume of space. As shown in FIG. 1, the housing 145 also includes three arms 147 radially extended over the plurality of impeller blades 143 and connected to three correspondingly struts 148 that are respectively fixed by three pins on the plate 110. Of course, there can be other alternatives or modifications. In general, the apparatus can be applied to much broader areas of fluid flow processing, especially when axial flow is required to be transformed into radial flow.

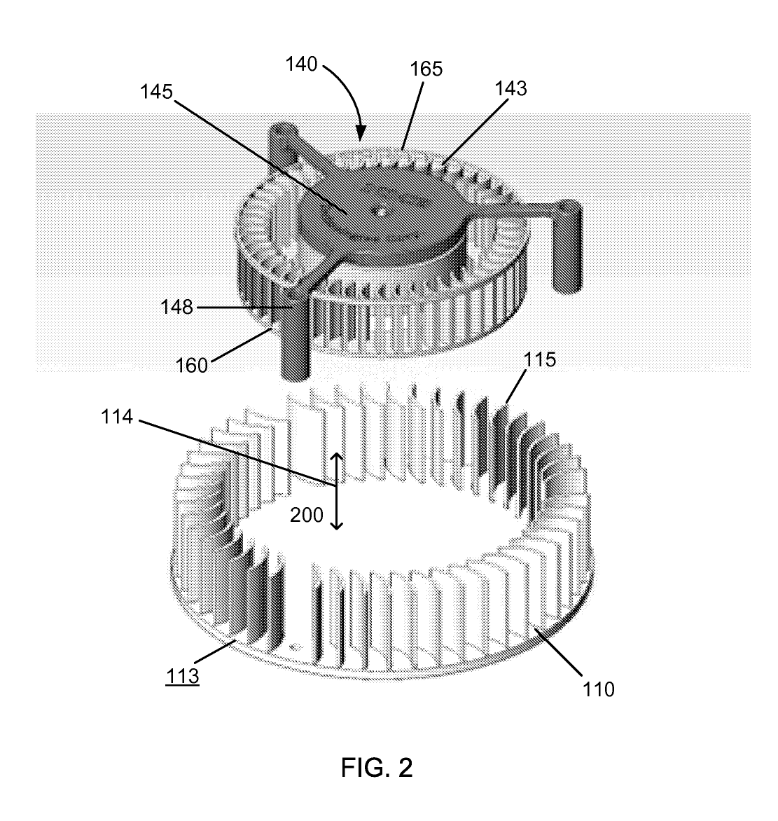

FIG. 2 is a schematic diagram of the apparatus of FIG. 1 partially disassembled according to an embodiment of the invention. This diagram is merely an example, which should not unduly limit the scope of the claims herein. One of ordinary skill in the art would recognize many variations, alternatives, and modifications. As shown, the blower impeller 140 is disassembled from the base plate 110 and is raised above a distance to illustrate the central volume of space 200 defined by the plurality of fins 115 circumferentially arranged about the periphery 113 of the plate 110. Each of the plurality of fins 115 is substantially identical in a lateral size, a height and an equal spacing from its neighboring fin. In a specific embodiment, the central volume of space 200 is a substantially a column of space defined by a central area of the plate 110 and a height 114 substantially equal to the height of corresponding the plurality of fins 115. In one example, three of the plurality of fins 115 located in three separate positions along the peripheral region are replaced by three pins for respectively mating with three struts 148 connected to the housing 145 of a rotor (not visible). Of course, there can be other variations, alternatives, and modifications in the arrangement of the plurality of fins and the ways of mounting the housing 145 of the rotor.

Referring to FIG. 2 again, the blower impeller 140 also includes a ring-shaped plate 160 radially coupled to the rotor to serve as a common base for supporting the plurality of impeller blades 143, on which each of the plurality of impeller blades 143 is vertically attached and arranged in a radial distribution arrangement. In a specific embodiment, the ring-shaped plate 160 is configured to be fit in an outer circumferential portion within the central volume of space with at least a gap apart from the plurality of fins 115. At the same time, the assembly position of the ring-shaped plate 160 has a gap distance sufficiently clear from the top surface 111 of the circular plate 110 to allow free rotary motion of the ring-shaped plate 160 driven by the rotor. In another specific embodiment, the blower impeller 140 further includes another ring structure 165 for attaching an upper corner of each impeller blade. The ring structure 165 has a substantially smaller physical dimension compared to the ring-shaped plate 160 simply for providing additional mechanical support. Of course, there can be other variations, alternatives, and modifications.

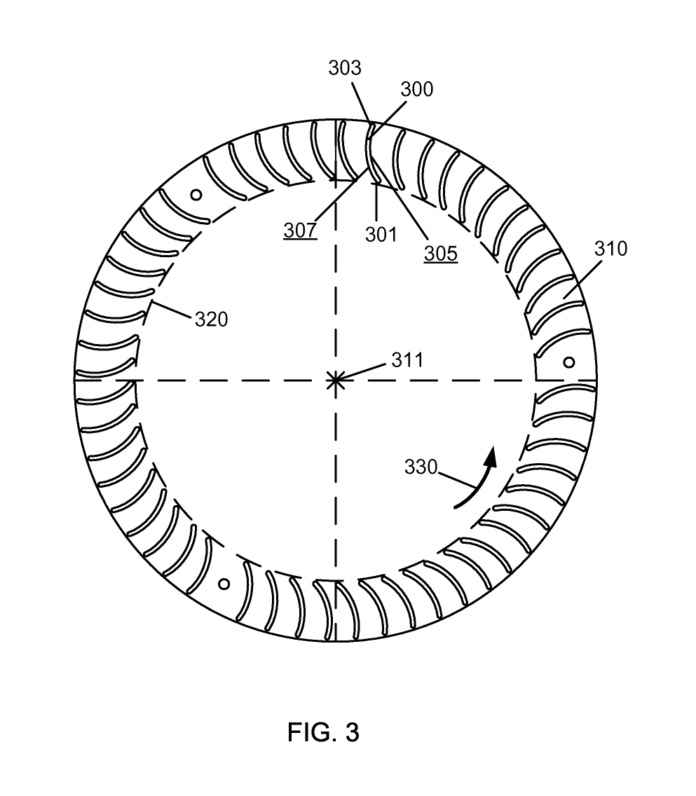

FIG. 3 is a schematic top view of a plurality of fins radially disposed on a circular plate of the apparatus according to an embodiment of the invention. This diagram is merely an example, which should not unduly limit the scope of the claims herein. One of ordinary skill in the art would recognize many variations, alternatives, and modifications. As shown, the plurality of fins 300 are vertically coupled to a circular plate 310 (with a center 311) so that their cross sectional shapes are shown to be an airfoil shape bearing aerodynamic characteristics for facilitating fluid flow and heat transfer in radial directions. In one embodiment, the plurality of fins 300 is substantially the same as the plurality of fins 115 shown in FIG. 1. In particular, each airfoil-shaped fin 300 includes a leading edge 301 facing an inflow of fluid from central portion of the plate 310 and a trailing edge 303 near the periphery of the plate, connected by two curved side surfaces: a concave side surface 305 and a convex side surface 307. In one specific embodiment, the curvature of either the concave side surface 305 or the convex side surface 307 can be adjustably adapted for certain fluid flow characteristics associated with different blower design used. For example, both side surface can have substantially the same curvature. In another example, the curvature of the convex side surface 307 is different from the curvature of the concave side surface 305. Both the leading edge 301 and the trailing edge 303 can be rounded to reduce flow turbulence. Of course, there can be many alternatives, variations, and modifications.

In another specific embodiment, the plurality of fins 300 and the associated circular plate 310 should be stationary. In cooling application of the apparatus a bottom surface (not visible) of the circular plate is used for attaching with an object to be cooled. The dashed circle 320 defines a central area ready for installing a blower impeller as an assembled air cooling apparatus. As indicated by the arrow head 330, the to-be-installed blower impeller is designed for rotary motion in counter-clockwise direction. Therefore, the plurality of fins 300 as shown have their concave side surfaces 305 facing the counter-clockwise direction arrow head 330. This is naturally accommodated for the air flow pattern to be generated by the rotary motion of the blower impeller. Of course, the blower impeller can be operated to rotate in clockwise direction while the fins 300 correspondingly reverse to still allow their concave side surfaces 305 facing a revered arrow head. More detail descriptions of the arrangement of each curved airfoil-shaped fin as well as their relationship with the to-be-installed blower impeller can be found in following paragraphs.

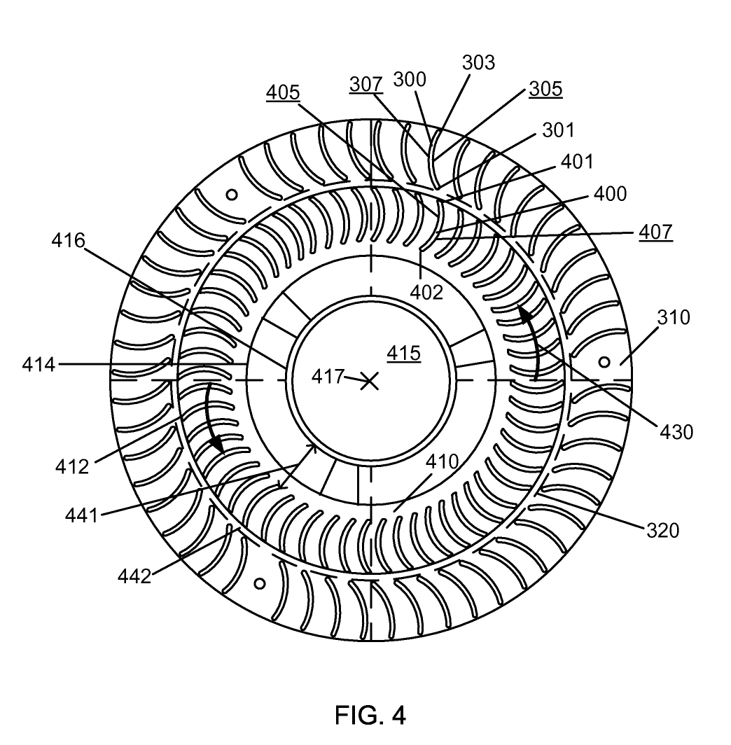

FIG. 4 is a schematic top view of a blower impeller associated with the plurality of fins of FIG. 3 according to an embodiment of the invention. This diagram is merely an example, which should not unduly limit the scope of the claims herein. One of ordinary skill in the art would recognize many variations, alternatives, and modifications. As shown, the blower impeller (not fully shown) includes a ring-shaped plate 410 radially coupled to a rotor 415 enclosed by a housing 416 in the central portion about an axis of rotation 417. The ring-shaped plate 410 has an outer periphery 412 and an inner periphery 414 and is in parallel to the circular plate 310. The ring-shaped plate 410 is coaxial with the axis of the rotation 417 which is perpendicular to the top surface of the plate 310 through the center 311 (see FIG. 3). The blower impeller also includes a plurality of impeller blades 400 vertically fixed on the ring-shaped plate 410. Thus, FIG. 4 shows the cross sectional shape of each impeller blade 400. In one example, the shape of each impeller blade is an arc shaped having a first edge 401 and a second edge 402 connected by a pair of curved side surfaces: a concave side surface 405 and a convex side surface 407. In a specific embodiment, the plurality of impeller blades 400 are to be driven by the rotor 415 for rotary motion, for example a counter-clockwise rotation indicated by arrow head 430, about the axis of rotation 417. In the example shown in FIG. 4, the concave side surface 405 of each impeller blade 400 is located ahead of the convex side surface 407 during the rotary motion along the counter-clockwise direction, which effectively generates radial directional air flow. Of course, embodiments of the invention applies clockwise rotation if every blade or fin is reversely disposed or curved in an opposite way.

In one specific embodiment, each of the plurality of impeller blades 400 is substantially identical with a lateral size smaller than the space between the outer periphery 412 and the inner periphery 414. The plurality of impeller blades 400 are arranged uniformly along the ring-shaped plate 410 with the first edge 401 of each impeller blade substantially aligning about the outer periphery 412 and the second edge 402 in corresponding radial direction near the inner periphery 414. As shown, a gap 441 exists between the inner periphery 414 and the housing 416 and a gap 442 exists between the outer periphery 412 and the circle 320 defined by the lead edges 301 of the plurality of fins 300. The gap 441 is bigger than the gap 442. In addition, in an preferred embodiment each of the impeller blades 400 is curved as to accommodate corresponding one of airfoil-shaped fins 300 curved in an opposite way. As a result, radial air flow created by the plurality of impeller blades 400 can be smoothly diffused out through the plurality of airfoil-shaped fins 300. The gap 442 can be made small for saving space and reducing possible flow disturbance. Furthermore, the curvature of either the concave side surface 405 or the convex side surface 407 can be the same or different, depending on the choice of the rotors and specific operation conditions. More detail description of the arrangement of each impeller blade and/or each airfoil-shaped fin with respect to one or more radial directions can be found in following paragraphs.

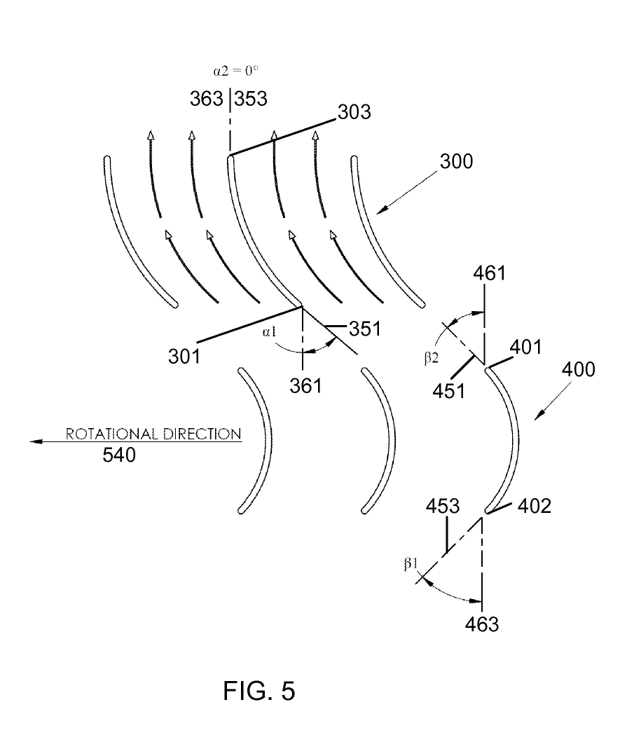

FIG. 5 is a cross sectional view illustrating an exemplary arrangement of both the plurality of fins and plurality of impeller blades according to an embodiment of the present invention. This diagram is merely an example, which should not unduly limit the scope of the claims herein. One of ordinary skill in the art would recognize many variations, alternatives, and modifications. As shown, a rotational direction is marked by arrow 540 and orientational arrangements within the cross sectional plane for the stationary airfoil-shaped fins 300 and rotary arc-shaped impeller blades 400 are illustrated. Firstly, each airfoil-shaped fin 300 is orientated in such a way that the convex curved side is ahead of the concave side in the rotational direction 540. The curved sides of each arc-shaped fin 300 are further orientated such that a tangential direction 351 at the leading point 301 is pointing towards somewhat opposite to the rotational direction 540 and forming a leading edge inlet angle α1 with respect to a radial direction 361 associated with the leading point 301. In a specific embodiment, the inlet angle α1 is equal to about 60 degrees. Embodiments of the invention allows certain ranges for the inlet angle α1 depending on applications. For example, the range of the inlet angle α1 can be from 50 to 65 degrees. For the same airfoil-shaped fin 300, the tangential direction 353 associated with the trailing point 303 forms a trailing edge exit angle α2 with respect to another radial direction 363 associated with the trailing point 303. In a specific embodiment, the trailing edge exit angle α2 is substantially equal to zero degrees for the purpose of easily diffusing the outflow of air or other fluid in each radial direction.

Secondly, FIG. 5 also shows an exemplary arrangement of the arc-shaped impeller blades 400 which are associated with a same center of the airfoil-shaped fins 300 mentioned above for defining corresponding radial directions. In particular, the arc-shaped impeller blades 400 are supposed to rotate along the marked rotational direction 540. Each impeller blade 400 is orientated such that the concave side is ahead of the convex side during the rotation. In addition, a tangential direction 451 associated with the first edge point 401 is off an angle β2 with respect to a radial direction 461 associated with the point 401. At the same time, a tangential direction 453 associated with the second edge point 402 is off an angle β1 with respect to another radial direction 463 associated with the second edge point 402. In one embodiment, the angle β1 is equal to about 45 degrees and the angle β2 is equal to about 45 degrees. In another embodiment, the radial direction 461 and the another radial direction 463 is substantially a same radial direction. Furthermore, FIG. 5 shows that the first edge point 401 of the arc-shaped impeller blade 400, at one position during the rotation of the impellers, is located close to the leading edge point 301 with a space apart. FIG. 5 is not proportionally drawn in scale and can vary for different applications. One skilled in the art would recognize many variations, alternatives, and modifications of the specific length along either the curved airfoil-shaped fin or the arc-shaped impeller or the space apart between them.

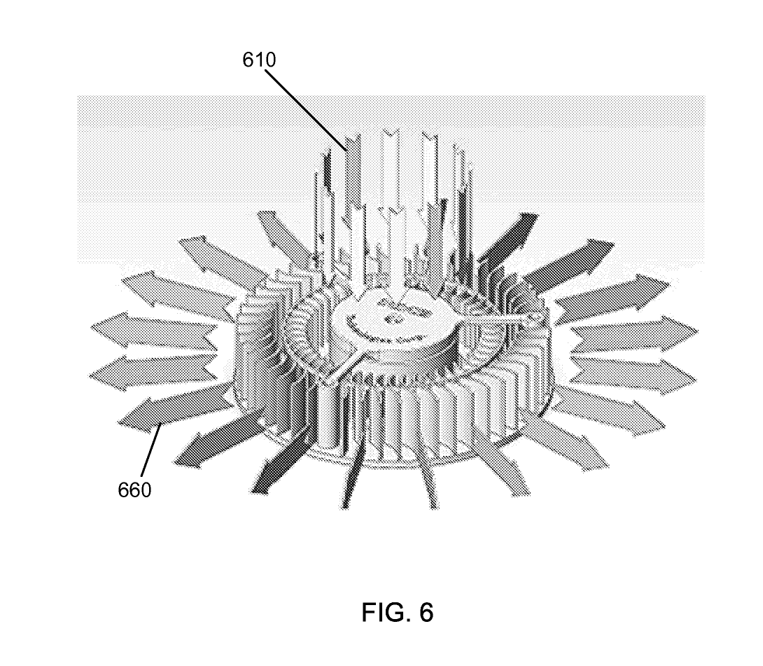

FIG. 6 is a schematic diagram illustrating a method of using the apparatus according to an embodiment of the present invention. This diagram is merely an example, which should not unduly limit the scope of the claims herein. One of ordinary skill in the art would recognize many variations, alternatives, and modifications. The apparatus according to an embodiment of the present invention can be used for fluid flow process. In particular, the apparatus is provided as an air cooling apparatus. The air cooling apparatus includes a plate including a first surface, a second surface, and a plurality of airfoil-shaped fins being integrally coupled with the first surface in a radial arrangement along periphery of the plate. The radial arrangement of the plurality of airfoil-shaped fins defines a central volume of space. Additionally, the air cooling apparatus includes a blower impeller including a plurality of impeller blades radially coupled to a rotor. The blower impeller is rotatably disposed within the central volume of space for rotary motion about an axis of rotation which is perpendicular to the first surface. In particular, the air cooling apparatus just provided is the same as the apparatus 100 described throughout the specification.

Secondly, the method further includes making a thermal contact between the second surface and the object, thereby conducting heat from the object through the plate to the plurality of airfoil-shaped fins. Both the plate and the plurality of airfoil-shaped fins are made by special heat-conductive materials for facilitating the conduction. For example, the airfoil-shaped fins are made of alloys of aluminum or copper or thermal conducting plastics. The plurality of airfoil-shaped fins serve as heat sinks to the plate.

Thirdly, the method additionally includes driving the rotary motion of the blower impeller by powering the rotor. For example, the rotor is part of an electric-powered rotary motor provided by NMB (USA) Inc., a division of Minebea Co. LTD. Japan, or product from any other micro motor suppliers. The rotor is enclosed within a housing which is disposed in central portion of the central volume of space around the axis of rotation. The rotor essentially drives a rotation of the plurality of impeller blades about the same axis of rotation. The housing is fixed with the plate and is stationary together with the plurality of airfoil-shaped fins integrally attached with the plate.

Fourthly, the method further includes creating an air inflow into the central volume of space along the axis of rotation caused by the rotary motion of the plurality of impeller blades. As seen from FIG. 6, a gap exists between the housing of the rotor and the plurality of impeller blades. The rotation of the radially arranged impeller blades causes a pressure difference along axial direction. Therefore, more air is sucked into the gap along the direction in parallel to the axis of rotation as indicated by the down-pointed arrows 610 in FIG. 6. This air inflow is a supply of cold air. For example, the axial direction is aligned to an window of an assembled electronics product so that the air sucked in can be cold relative to the heated electronics product. Furthermore, the cold air is delivered towards the plurality of impeller blades through the gap.

Finally, the method includes a process of blowing the cold air by the rotary motion of the plurality of impeller blades and at the same time a process of pushing it through the plurality of airfoil-shaped fins to diffuse the heat out in radial directions. This process essentially occurs as soon as the blower impeller starts rotate. The incoming axial air flow is turned into a radial air flow out of the plurality of impeller blades. In one embodiment, extra pressure is added due to the rotary motion of the properly curved impeller blades. Further, the plurality of stationary airfoil-shaped fins correspondingly arranged around the plurality of impeller blades act as guides for the radial air flow to smoothly pass through open spaces between the plurality of airfoil-shaped fins. In the process, the radial air flow effectively takes the heat away from the plurality of airfoil-shaped fins and the plate. Subsequently, the heated air is diffused out in all radial directions, as indicated by the radially out-pointed arrows 660 in FIG. 6.

Many benefits are achieved by applying embodiments of the present invention. An embodiment enhances the heat removal process by utilizing the blower bladed-diffuser. Each of the diffuser blades or fins on the diffuse plate is a heat sink and the plate itself is a heat spreader. Another embodiment with the blower impeller being embedded in the central portion of the diffuser blades or fins makes the overall unit very compact and reduces cost of manufacture compared to making a separate fan unit versus the heat spreader. This is very useful for many new generation electronics products requiring much tighter assembly spacing more stringent demand on cooling efficiency. Certain embodiments of the present invention make the air cooling more efficient by removing the heat through effectively combined conduction and convection. Additionally, embodiments of the present invention should be applicable for processing various kinds of fluid including air, mixed gases, water, solution, liquid mixture, etc. without unduly limit the scope of the claims herein.

It is also understood that the examples and embodiments described herein are for illustrative purposes only and that various modifications or changes in light thereof will be suggested to persons skilled in the art and are to be included within the spirit and purview of this application and scope of the applied claims.

What is claimed is:

1. An apparatus for air cooling an object, the apparatus comprising
a plate including a first surface and a second surface;
a plurality of aerodynamic fins being fixedly disposed on the first surface in an arrangement along periphery of the plate, the arrangement of the plurality of aerodynamic fins defining a central volume of space; and
a blower impeller rotatably disposed within the central volume of space for rotary motion about an axis of rotation;
wherein:
the second surface is for thermally contacting with the object;
the axis of rotation is substantially perpendicular to the first surface;
the rotary motion of the blower impeller creates an air inflow into the central volume of space along the axis of rotation and an air outflow in radial directions through the plurality of aerodynamic fins.

2. The apparatus of claim 1 wherein the plate comprises a thermally conductive material in a circular, or a polygonal, or an oval shape.

3. The apparatus of claim 1 wherein the plurality of aerodynamic fins comprise thermally conductive materials including alloys of aluminum, or alloys of copper, or conductive polymer or plastics.

4. The apparatus of claim 1 wherein each of the plurality of aerodynamic fins comprises an arc-like shaped blade curved from a leading edge to a trailing edge.

5. The apparatus of claim 4 wherein the arrangement of the plurality of aerodynamic fins comprises a distribution of each arc-like shaped blade with substantially an equal spacing apart from a neighboring blade, the leading edge stood near the central volume of space, and the trailing edge stood near the periphery of the plate.

6. The apparatus of claim 5 the arrangement of the plurality of aerodynamic fins further comprises a first angle characterized for each arc-like shaped blade disposed relative to the first surface.

7. The apparatus of claim 6 wherein the first angle is about 90 degrees.

8. The apparatus of claim 5 wherein the arrangement of the plurality of aerodynamic fins further comprises a second angle and a third angle characterizing orientation for each arc-like shaped blade within the first surface, the second angle being an inlet angle measured from a tangential direction of the leading edge to a corresponding radial line, the third angle being an exit angle measured from a tangential direction of the trailing edge to a corresponding radial line, the second angle being substantially equal to zero degrees and the third angle being between about 50 degrees and about 60 degrees.

9. The apparatus of claim 1 wherein the blower impeller comprises:
a rotor co-axial with the axis of rotation;
a housing enclosing the rotor to occupy an inner circumferential portion of the central volume of space;
a ring-shaped plate being radially coupled with the rotor for rotary motion around the housing; and
a plurality of impeller blades being fixedly arranged about the ring-shaped plate, the arrangement of the plurality of impeller blades radially occupying an outer circumferential portion of the central volume of space, the outer circumferential portion being spaced apart a first gap from the inner circumferential portion and a second gap from the plurality of aerodynamic fins.

10. The apparatus of claim 9 wherein the second gap is substantially smaller than the first gap.

11. The apparatus of claim 9 wherein the ring-shaped plate is disposed above and in parallel relation to the first surface.

12. The apparatus of claim 9 wherein the housing comprises one or more arms radially extended to connect one or more support struts fixedly coupled with the plate.

13. The apparatus of claim 9 wherein each of the plurality of impeller blades is an arc-shaped blade vertically disposed on the ring-shaped plate with substantial equal spacing to each other, the arc-shaped blade including a first edge and a second edge connected by a concave side opposing a convex side.

14. The apparatus of claim 13 wherein the concave side leads the convex side in a rotational direction.

15. The apparatus of claim 13 wherein the arrangement of the plurality of impeller blades comprises a fourth angle and fifth angle characterizing orientation for each arc-shaped blade within the ring-shaped plate, the fourth angle being a tangential angle associated with corresponding first edge, the fifth angle being a tangential angle associated with corresponding second edge, the fourth angle and the fifth angle being substantially the same and about 45 degrees.

16. The apparatus of claim 9 further comprising a ring structure separated from the ring-shaped plate within the central volume of space, the ring structure being fixedly attached with a portion of each of the plurality of impeller blades for mechanical support.

17. An apparatus for processing fluid flow, comprising,
a circular plate;
a plurality of curved fins fixedly disposed in an arrangement radially about periphery of the circular plate, the arrangement of the plurality of curved fins defining a central volume of space;
a blower impeller including a rotor enclosed within a housing and a plurality of impeller blades coupled to the rotor for rotary motion about an axis of rotation, the housing being fixedly attached with the circular plate and occupied an inner circumferential portion of the central volume of space, the plurality of impeller blades being radially arranged about outer circumferential portion of the central volume of space, the outer circumferential portion being spaced apart a first gap from the inner circumferential portion and a second gap from the plurality of curved fins;
wherein:
the axis of rotation is perpendicularly centered with the circular plate;
the rotary motion of the plurality of impeller blades creates a fluid inflow into the first gap within the central volume of space along the axis of rotation and drives a fluid outflow crossing the second gap and passing through the plurality of curved fins in radial directions.

18. The apparatus of claim 17 wherein each of the plurality of curved fins is a first airfoil-shaped blade including a leading edge facing the fluid outflow generated from the plurality of impeller blades, a trailing edge near periphery of the circular plate, a convex side, and a concave side opposing to the convex side, the leading edge being connected to the trailing edge by the convex side and the concave side.

19. The apparatus of claim 18 wherein the arrangement of the plurality of curved fins comprises a distribution of the first airfoil-shaped blade with a substantial equal spacing apart from neighboring blade and an orientation characterized by a side angle, a trailing edge exit angle and a leading edge inlet angle.

20. The apparatus of claim 19 wherein:
the side angle is about 90 degrees measured between the convex side/concave side and the circular plate;
trailing edge exit angle is substantially zero degrees measured from a tangential direction to a corresponding radial direction for the trailing edge;
the leading edge inlet angle is between about 50 and 65 degrees measured from a tangential direction to a corresponding radial direction for the leading edge.

21. The apparatus of claim 17 further comprising a ring-shaped plate in parallel to the circular plate and radially coupled with the rotor, serving as a common base for the plurality of impeller blades.

22. The apparatus of claim 21 wherein each of the plurality of impeller blades comprises a second airfoil-shaped blade vertically coupled with the ring-shaped plate, the second airfoil-shaped blade including a first edge near the plurality of curved fins, a second edge near the housing of rotor, a convex side, and a concave side opposing to the convex side, the first edge being connected to the second edge by the convex side and the concave side.

23. The apparatus of claim 22 wherein the second airfoil-shaped blade is oriented such that a first tangential direction at the first edge within the ring-shaped plate is off a first angle from a third radial direction corresponding to the first edge, and a second tangential direction at the second edge within the ring-shaped plate is off a second angle from a fourth radial direction corresponding to the second edge.

24. The apparatus of claim 23 wherein the third radial direction is substantially the same as the fourth radial direction and the first angle and the second angle are substantially the same about 45 degrees.

25. The apparatus of claim 21 further comprising a ring structure spaced apart from the ring-shaped plate, the ring structure being coaxial with the axis of rotation and attached with a portion of each of the plurality of impeller blades for mechanical support.

26. A method of cooling an object, the method comprising:
providing an air cooling apparatus, the apparatus including:
a plate including a first surface and a second surface;
a plurality of airfoil-shaped fins being integrally coupled with the first surface in a radial arrangement along periphery of the plate, the radial arrangement of the plurality of airfoil-shaped fins defining a central volume of space; and
a blower impeller including a plurality of impeller blades radially coupled to a rotor and rotatably disposed within the central volume of space for rotary motion about an axis of rotation, wherein the axis of rotation is perpendicular to the first surface;
making a thermal contact between the second surface and the object, thereby conducting heat from the object through the plate to the plurality of airfoil-shaped fins;
driving the rotary motion of the plurality of impeller blades by powering the rotor;
creating an inflow of air along the axis of rotation into the central volume of space; and
driving the air through the plurality of airfoil-shaped fins to diffuse the heat out in radial directions.

27. The method of claim 26 wherein the providing the air cooling apparatus further comprises arranging the plurality of airfoil-shaped fins and the plurality of impeller blades such that:
each of the plurality of airfoil-shaped fins includes arc-curved side-surfaces substantially perpendicular to the first surface from a leading edge to a trailing edge and is spaced apart from a neighboring airfoil-shaped fin by a first separation, thereby forming an aerodynamic air flow channel between each neighboring airfoil-shaped fins;
each of the plurality of impeller blades includes arc-curved side-surfaces substantially parallel to the axis of rotation from a first edge to a second edge and is spaced apart from a neighboring impeller blade by a second separation, the first edge being near the leading edge during the rotary motion and the second separation being adapted to the first separation for facilitating the outflow of air.
